(19) United States
(12) Patent Application Publication
(10) Pub. No.: US 2023/0354884 A1
(43) Pub. Date: Nov. 9, 2023

(54) Aerosol Generation System

(71) Applicant: INNO-IT CO., LTD., Busan (KR)

(72) Inventors: Seung Kiu Jeong, Gyeongsangnam-do (KR); Hyuk Won, Busan (KR)

(21) Appl. No.: 17/776,826

(22) PCT Filed: Jan. 28, 2020
(86) PCT No.: PCT/KR2020/001280

§ 371 Date: May 13, 2022

(30) Foreign Application Priority Data
Jan. 24, 2019 (KR) 10-2019-0009335
Sep. 27, 2019 (KR) 10-2019-0119221
Sep. 27, 2019 (KR) 10-2019-0119452
Dec. 11, 2019 (KR) 10-2019-0164580
Jan. 28, 2020 (KR) 10-2020-0009698

(51) Int. Cl. A24D 1/20; A24F 40/465; A24D 1/02; A24F 40/10; A24F 40/42; A24F 40/57; A24F 40/51; A24B 15/167

(52) U.S. Cl. CPC A24D 1/20; A24B 15/167; A24D 1/02; A24F 40/10; A24F 40/42; A24F 40/465; A24F 40/51; A24F 40/57

(57) ABSTRACT

The present invention relates to an aerosol generating system comprising an aerosol generating device and an electrically heated smoking article inserted into the aerosol generating device to generate aerosol. The present invention provides an aerosol generating system comprising: an electrically heated smoking article including a filter, a cartridge comprising an absorbent receiving a liquid or gel aerosol-forming substrate, and wrapping paper wrapped around the filter and cartridge; and an aerosol generating device for heating the electrically heated smoking article.

### TECHNICAL FIELD

The present invention relates to an aerosol generating system comprising an aerosol generating device and an electrically heated smoking article inserted into the aerosol generating device to generate aerosol.

### BACKGROUND

In recent years, the demand for alternatives for addressing the shortcomings of traditional cigarettes is increasing. For instance, there is a growing demand for methods of generating an aerosol by heating an aerosol-generating material in a cigarette, instead of burning tobacco.

Typically, a reconstituted tobacco slurry sheet, which is the main ingredient of the tobacco substrate, is not easy to manufacture because of its low tensile strength, and its physical properties are weak because the tobacco substrate contains large amounts of humectants. Moreover, the tobacco substrate contains a liquid such as glycerin and is sensitive to the humidity in the surroundings due to its hydrophilic nature, which makes it difficult to control the environment of the manufacturing process. Also, the tobacco substrate can contain only a limited amount of liquid.

Aside from cigarettes comprising the tobacco substrate, there have been proposed cigarettes, which generate more aerosol from liquid contained in a cartomizer and let the user inhale an aerosol derived from the liquid when they puff on the cigarette. However, there are difficulties (expiration date, deterioration, etc.) in managing the liquid contained in the cartomizer, and contamination can occur as condensate is generated in the airflow path through which the aerosol created by the cartomizer moves.

This creates a need to provide a liquid into an electrically heated smoking article which is disposed after used once and produce an aerosol from the liquid.

### SUMMARY

An object of the present invention is to solve the problems occurring in the prior art and provide a liquid cartridge that can be inserted into an electrically heated smoking article and an electrically heated smoking article including the same.

In view of this, the present invention provides an aerosol generating system comprising: an electrically heated smoking article including a filter, a cartridge comprising an absorbent receiving a liquid and/or gel aerosol-forming substrate (hereinafter, also referred to as liquid absorbent, gel absorbent, or aerosol-forming substrate absorbent), and wrapping paper wrapped around the filter and cartridge; and an aerosol generating device for heating the electrically heated smoking article.

Here, it is desirable that the absorbent has a sufficient absorption rate to absorb 70 to 120 mg of liquid aerosol-forming substrate and keep the same in the cartridge.

In addition, the liquid aerosol-forming substrate may contain glycerin VG and optionally contain glycerin PG, water, and flavorings, and the liquid composition may contain 70 to 100 wt% glycerin VG, 0 to 20 wt% glycerin PG, and 0 to 10 wt% water and further contain flavorings added in an amount that is 10% or less of the total weight of the resulting liquid composition.

Alternatively, the gel aerosol-forming substrate may contain glycerin and gelatin which exists in gel form, semi-solid form, or solidified form in a first temperature range including room temperature, changes to a liquid form in a second temperature range including 70° C., and is vaporized into an aerosol in a temperature range of 150 to 400° C.

Here, the gel aerosol-forming substrate may additionally contain one or more among water, agar, a thickener, starch powder, celluloses, carboxymethyl ethers, natural food flavor, and fruit extract.

In this case, it is desirable that the content of glycerin in the gel aerosol-forming substrate is equal to or greater than 50 wt%.

Alternatively, the gel aerosol-forming substrate may contain a liquid composition made up of 80 to 100 wt% glycerin VG and 0 to 20 wt% glycerin PG, wherein 1 to 6 g of gelatin may be contained in 100 ml of a mixture of 60 to 80% liquid composition and 20 to 40% water by volume, and flavorings may be optionally added in an amount that is 10% or less of the total weight of the liquid composition.

Here, the gel absorbent may contain the liquid composition in an amount of 70 to 120 mg.

The gel aerosol-forming substrate may be inserted in liquid form into the gel absorbent in the second temperature range, and exist in gel form, semi-solid form, or solidified form in the first temperature range.

As an example, it is desirable that the absorbent is made by crumpling or rolling a strip made of a melamine-based foam resin with a thickness of 2 to 3 mm into a cylindrical shape or by processing a melamine-based foam resin into a cylindrical shape, and optionally has a weight of 0.01 to 0.013 mg/mm³ per unit volume.

As another example, it is desirable that the absorbent is made by crumpling, folding, or rolling pulp or a fabric containing pulp into a cylindrical shape or by processing the same into a cylindrical shape, and optionally has a weight of 0.25 to 0.4 mg/mm³ per unit volume.

As a further example, it is desirable that the absorbent is made by crumpling or rolling a cotton woven or non-woven fabric into a cylindrical shape or by processing the same into a cylindrical shape, and optionally has a weight of 0.2 to 0.35 mg/mm³ per unit volume.

As a yet further example, it is desirable that the absorbent is made by crumpling or rolling a bamboo fiber woven or non-woven fabric into a cylindrical shape or by processing the same into a cylindrical shape, and optionally has a weight of 0.15 to 0.25 mg/mm³ per unit volume.

It is desirable that the aerosol-forming substrate is absorbed in the liquid absorbent, in an amount of 0.13 to 0.32 mg/mm³ per unit volume of the absorbent.

Further, the wrapping paper may be made by attaching aluminum foil to paper, and may be wrapped in a cylindrical shape so that the aluminum foil comes into contact with the absorbent.

Furthermore, a tubular body may be provided directly upstream of the filter.

Moreover, the aerosol generating device, which is grippable and portable-sized, may comprise: a cavity provided in the device into which the smoking article can be inserted; at least one of a resistance heater and an induction heater provided in the device, that can heat the interior or exterior of a liquid cartridge and tobacco filler of the smoking article; a rechargeable battery provided in the device to function as a direct current power source; and a control unit provided in the device to control the heaters by receiving direct current power from the battery.

Here, the resistance heater may be a pipe heater for heating the exterior of the smoking article, wherein the pipe heater may heat the aerosol-forming substrate cartridge and may further comprise a temperature sensor provided in the device to sense the temperatures of the heaters, and the control unit may control the resistance heater according to a sensed value from the temperature sensor.

In addition, the induction heater may be a heat pipe made of a susceptor material that heats the exterior of the smoking article, heated by an excitation coil provided separately in the device, wherein the heat pipe may heat the aerosol-forming substrate cartridge and may further comprise a temperature obtaining unit provided in the device to obtain the temperature of the induction heater, and the control unit may control the electrical current applied to the excitation coil based on an input from the temperature obtaining unit.

According to the present invention, it is possible to solve the problems occurring in the prior art when the user inhales an aerosol derived from a liquid and an aerosol derived from a tobacco substrate, by providing a liquid cartridge that can be inserted into an electrically heated smoking article and an electrically heated smoking article including the same.

### BRIEF DESCRIPTION OF THE DRAWINGS

FIG. 1 conceptually shows a partial exploded perspective view and cross-sectional view of an electrically heated smoking article according to a preferred embodiment of the present invention.

FIG. 2 conceptually shows components of the smoking article of FIG. 1 and a construction of wrapping paper wrapped around them.

FIG. 3 is a conceptual diagram showing a process of manufacturing an absorbent rod in order to obtain the absorbent of FIG. 2.

FIG. 4 conceptually shows a process of cutting an absorbent rod in order to manufacture an aerosol-forming substrate cartridge according to the present invention from the absorbent rod of FIG. 3.

FIG. 5 schematically shows a cross-section of an aerosol generating device having a pipe-shaped resistance heater according to a first embodiment to which the electrically heated smoking article is applied.

FIG. 6 schematically shows a cross-section of an aerosol generating device having an induction heat pipe made of a susceptor material according to a second embodiment to which the electrically heated smoking article is applied.

### DETAILED DESCRIPTION

Certain embodiments will now be illustrated in the drawings and described in detail in the description, although various changes and modification can be made thereto. Features and advantages of the present invention and the manner of obtaining them will become more apparent by reference to the following description of the embodiments of the invention, taken in conjunction with the accompanying drawings. The present invention may, however, be embodied in different forms and should not be construed as limited to the embodiments set forth herein.

As used herein, the singular forms “a,” “an” and “the” are intended to include the plural forms as well, unless the context clearly indicates otherwise.

It will be further understood that the terms “comprises”, “comprising”, “includes” and/or “including”, when used herein, specify the presence of stated features or components, but do not preclude the presence or addition of one or more other features or components.

In the following embodiments, the terms “upstream” and “downstream” are used to describe the relative positions of segments of a smoking article in relation to the direction in which a user draws in air through the smoking article. The smoking article includes an upstream end (through which air enters) and an opposite downstream end (through which air exits). In use, the user draws on the downstream end of the smoking article and inhales air that is drawn through the upstream end of the smoking article, passes through the inside of the smoking article, and goes out to the downstream end. The downstream end is downstream of the upstream end. The term “end” may also be described as “extreme end”.

The drawings are not necessarily to scale; some features may be exaggerated or minimized to show details of particular components. Because the size and thickness of each configuration shown in the drawings are arbitrarily shown for better understanding and ease of description, the present invention is not limited thereto.

Example embodiments of the present invention will now be described in detail with reference to the accompanying drawings, so that the present invention can be easily implemented by those skilled in the art. However, the present invention may be implemented in various different ways, without being limited to the described embodiments.

A cartridge comprising a liquid or gel aerosol-forming substrate that can generate an aerosol by heating, an electrically heated smoking article including the liquid cartridge, and an aerosol generating device for heating the smoking article according to preferred embodiments of the present invention will now be described with reference to the accompanying drawings. For easy explanation, components of the electrically heated smoking article will be described individually, together with a description of the liquid or gel aerosol-forming substrate cartridge included therein. Here, the electrically heated smoking article is intended to indicate a smoking article which is heated by electric resistance or induction heating, not by burning, to generate an aerosol for inhalation by a user. The smoking article contains a proper amount of aerosol-forming substrate to take an equivalent number of puffs to a single traditional cigarette. The smoking article does not generate any more aerosol after generating a preset amount of aerosol and will be discarded by the user after used once.

The electrically heated smoking article according to the present invention comprises a liquid aerosol-forming substrate containing a liquid composition, like glycerin, or a (gelated or solidified) gel aerosol-forming substrate containing a liquid composition, like glycerin, as an aerosol-forming substrate, which will be described below. The electrically heated smoking article according to a first embodiment of the present invention has a laminate structure composed of a liquid composition and/or gel composition located at the upstream end as an aerosol-forming substrate, a tube located directly downstream thereof that provides an aerosol passage, and a filter functioning as a mouthpiece. An aerosol generating system according to the present invention comprises: a filter; a cartridge located upstream of the filter and comprising a liquid or gel aerosol-forming substrate and an absorbent receiving a liquid and/or gel aerosol-forming substrate; wrapping paper wrapped around the filter and cartridge; and an aerosol generating device for heating the cartridge.

The liquid aerosol-forming substrate cartridge (liquid cartridge) and the gel aerosol-forming substrate cartridge, which are provided as the cartridge of the present invention, will now be explained respectively for convenience of description. However, it will be apparent that the aerosol-forming substrate that can be applied to the cartridge is not classified as liquid form or gel form, but may exist in both liquid form and gel form, which will be described later. Reference will be made to the same figures.

### Liquid Aerosol-Forming Substrate Cartridge (Liquid Cartridge)

The liquid cartridge 56 according to the present invention comprises: a liquid composition; an absorbent 56a soaked with the liquid composition; and wrapping paper 61 wrapped around the side of the absorbent in a cylindrical shape measuring 7 to 20 mm long and 5 to 8 mm in diameter, wherein the absorbent has a sufficient absorption rate to absorb 70 to 120 mg of liquid composition and keep it in the liquid cartridge 56. The cylindrical shape measuring 7 to 20 mm long and 5 to 8 mm in diameter meets the standard for regular cigarettes or electrically heated smoking articles being currently used. When the liquid cartridge 56 of the above standard is inserted into the electrically heated smoking article 50 and wrapped in a separate piece of wrapping paper 60, the user will see no difference between the regular cigarettes and the electrically heated smoking articles.

The present invention is characterized in that the absorbent of the liquid cartridge 56 of the above standard absorbs 70 to 120 mg of liquid composition, and this numerical range indicates the amount of liquid composition that provides an aerosol derived from the liquid composition as well when the user inhales an aerosol from the tobacco filler 58 of shredded tobacco in a single cigarette stick for the electrically heated smoking article. If the amount of liquid composition absorbed by the absorbent 56a is less than the above lower limit (70 mg), the amount of aerosol derived from the liquid composition when the user inhales an aerosol from the tobacco filler 58 of shredded tobacco in the electrically heated smoking article would be insufficient. Thus, the amount of liquid composition absorbed by the liquid cartridge 56 should be equal to or greater than the above lower limit (70 mg). If the amount of liquid composition absorbed by the absorbent 56a exceeds the above upper limit (120 mg), it would be difficult to keep the liquid composition absorbed in the absorbent in the liquid cartridge of the above standard, causing the liquid composition to flow out of the liquid cartridge 56. Thus, the amount of liquid composition absorbed by the liquid cartridge should be equal to or less than the above upper limit (120 mg). A desirable range is between 80 and 110 mg, and a more desirable range is between 90 and 105 mg.

Another characteristic of the present invention is that the absorbent in the liquid cartridge 56 of the above standard has a sufficient absorption rate to keep the liquid composition having the above range in the liquid cartridge. That is, the liquid composition remains absorbed in the absorbent in the liquid cartridge, without flowing out of the liquid cartridge. Here, the absorption means that the absorbent is soaked with the liquid composition which does not flow out. As described below, the filter 52, paper tube 54, and liquid cartridge 56 are wrapped in the wrapping paper 60 to form the electrically heated smoking article 50, wherein the liquid cartridge 56 is brought into direct contact with the paper tube 54 or filter 52 without a separate member upstream or downstream, and the liquid composition absorbed by the absorbent 56a in the liquid cartridge 56 is stored in the absorbent 56a, but does not flow out toward the paper tube 54 or filter 52. To this end, the amount of liquid composition absorbed by the absorbent 56a is preferably 0.13 to 0.32 mg/mm³ per unit volume of the absorbent 56a. This numerical limitation is set for a similar reason to why the numerical limitation is set on the amount of liquid composition absorbed by the absorbent of the present invention. That is, if the amount of liquid composition absorbed by the absorbent 56a is not sufficient, i.e., less than the above lower limit (0.13 mg/mm³), the amount of aerosol derived from the liquid composition when the user inhales an aerosol from the shredded tobacco in the electrically heated smoking article 50 would be insufficient. Thus, the amount of liquid composition absorbed by the liquid cartridge should be equal to or greater than the lower limit (0.13 mg/mm³). If the amount of liquid composition absorbed by the absorbent exceeds the above upper limit (0.32 mg/mm³), it would be difficult to keep the liquid composition absorbed in the absorbent in the liquid cartridge of the above standard, causing the liquid composition to flow out of the liquid cartridge.

The liquid composition contains glycerin VG and optionally contains glycerin PG, water, and flavorings. The liquid composition contains 70 to 100 wt% glycerin VG, 0 to 20 wt% glycerin PG, and 0 to 10 wt% water and further contains flavorings added in an amount that is 10% or less of the total weight of the resulting liquid composition. According to a preferred embodiment, the present invention uses a liquid composition made of 100 wt% glycerin VG. According to another preferred embodiment, the present invention uses a liquid composition made of 80 wt% glycerin VG and 20 wt% glycerin PG. According to a further preferred embodiment, the present invention uses a liquid composition made of 75 wt% glycerin VG, 20 wt% glycerin PG, and 5 wt% water. According to a yet further preferred embodiment, the present invention further contains flavorings added in an amount that is 10% or less of the total weight of the resulting liquid composition. For example, the flavorings may include licorice, sucrose, fructose syrup, isosweet, cocoa, lavender, cinnamon, cardamom, celery, cascarilla, fenugreek, cascarilla, sandalwood, bergamot, geranium, honey essence, rose oil, vanilla, lemon oil, orange oil, mint oil, caraway, cognac, jasmine, chamomile, menthol, ylang-ylang, salvia, spearmint, ginger, coriander, or coffee, etc. In addition, the liquid composition may or may not contain nicotine.

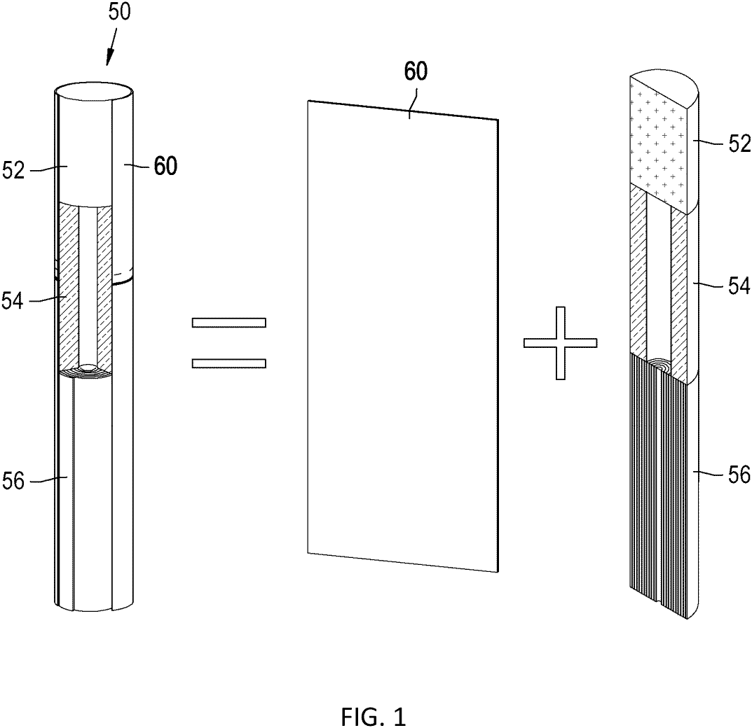

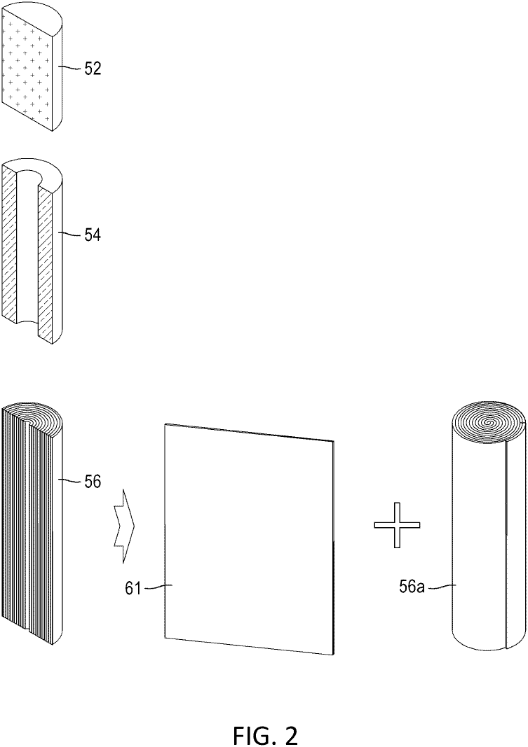

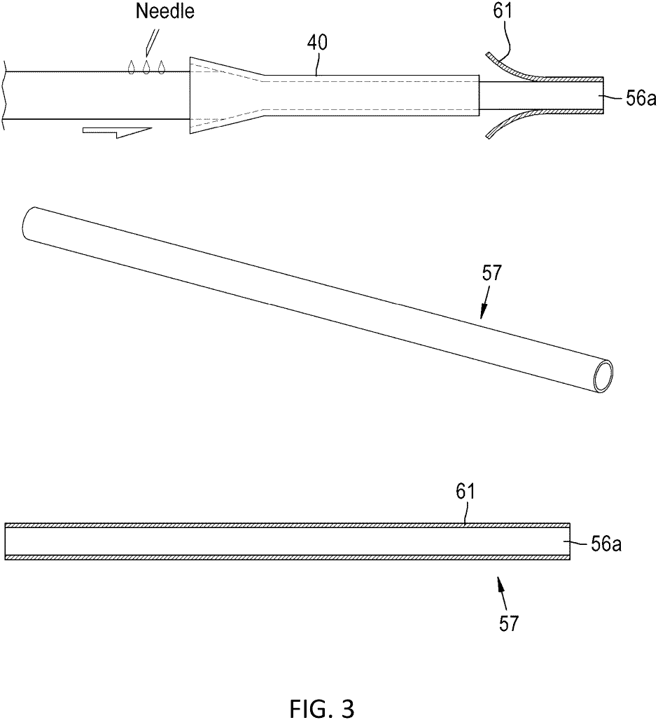

According to the present invention, the absorbent 56a may be made of various materials. Although FIGS. 1 and 2 illustrate that the absorbent 56a is formed in a rolled shape, this is only for convenience of description and the construction of the absorbent 56a is not limited thereto. Various types of absorbents 56a may be considered as stated below. Basically, an absorbent rod 57 may be obtained by crumpling or rolling the absorbent 56a, inserting it through one side of a pipe structure 40 shown in FIG. 3, pressing it into a shape with a narrower cross-section through the other side, and wrapping it in the wrapping paper 61. Before the absorbent 56a is inserted into the pipe structure 40, the liquid composition is provided into the absorbent 56a through a liquid composition injection part such as a needle. As the absorbent 56a passes through the pipe structure 40, it becomes dampened with the liquid composition, and is then wrapped in the wrapping paper 61 immediately on the other side of the pipe structure 40 and cut to an appropriate length, for example, 80 mm to 140 mm, thereby forming the absorbent rod 57. Thus, the absorbent rod 57 comes in the form of the absorbent 56a dampened with the liquid composition being wrapped in the wrapping paper 61. As stated later, the absorbent rod 57 is cut to a size that fits into an individual smoking article 50.

This construction is a generalized process in existing cigarette manufacturing lines, and has the advantage of using existing cigarette manufacturing processes and equipment. That is, the same process above applies to the conventional manufacturing of filters, paper tubes, and shredded tobacco, and the cartridge 56 can be produced using the equipment and processes currently used.

According to a preferred embodiment, the absorbent 56a of the present invention is made by crumpling or rolling a strip made of a melamine-based foam resin with a thickness of 2 to 3 mm and inserting it into the above-mentioned pipe structure 40 to form a cylindrical shape. According to another preferred embodiment, the absorbent of the present invention is made by processing a melamine-based foam resin into a cylindrical shape and inserting and pressing it into the above-mentioned pipe structure 40, and more preferably, the absorbent made of the melamine-based foam resin has a weight of 0.01 to 0.013 mg/mm³ per unit volume. According to test results for the electrically heated smoking article including the liquid cartridge having the absorbent soaked with 100 mg of liquid composition, the liquid composition remained absorbed in the gel absorbent without flowing out, during the test, a much greater amount of aerosol than in the existing heated cigarettes was observed, and a sufficient amount of aerosol derived from the liquid composition was observed, even compared to the existing hybrid types.

According to a further preferred embodiment, the absorbent of the present invention is made by crumpling, folding, or rolling pulp or a fabric containing pulp and inserting it into the above-mentioned pipe structure 40 to form a cylindrical shape or by processing it into a cylindrical shape and inserting and pressing it into the above-mentioned pipe structure 40, and more preferably, the absorbent made of pulp or a fabric containing pulp has a weight of 0.25 to 0.4 mg/mm³ per unit volume. According to test results for the electrically heated smoking article including the liquid cartridge having the absorbent soaked with 100 mg of liquid composition, the liquid composition remained absorbed in the absorbent without flowing out, during the test, a much greater amount of aerosol than in the existing heated cigarettes was observed, and a sufficient amount of aerosol derived from the liquid composition was observed, even compared to the existing hybrid types.

According to a yet further preferred embodiment, the absorbent of the present invention is made by crumpling or rolling a cotton woven or non-woven fabric and inserting it into the above-mentioned pipe structure 40 to form a cylindrical shape or by processing it into a cylindrical shape and inserting and pressing it into the above-mentioned pipe structure 40, and more preferably, the absorbent made of a cotton woven or non-woven fabric has a weight of 0.2 to 0.35 mg/mm³ per unit volume. According to test results for the electrically heated smoking article including the liquid cartridge having the absorbent soaked with 100 mg of liquid composition, the liquid composition remained absorbed in the absorbent without flowing out, during the test, a much greater amount of aerosol than in the existing heated cigarettes was observed, and a sufficient amount of aerosol derived from the liquid composition was observed, even compared to the existing hybrid types.

According to a yet further preferred embodiment, the absorbent of the present invention is made by crumpling or rolling a bamboo fiber woven or non-woven fabric and inserting it into the above-mentioned pipe structure 40 to form a cylindrical shape or by processing it into a cylindrical shape and inserting and pressing it into the above-mentioned pipe structure 40, and more preferably, the absorbent made of a bamboo fiber woven or non-woven fabric has a weight of 0.15 to 0.25 mg/mm³ per unit volume. According to test results for the electrically heated smoking article including the liquid cartridge having the absorbent soaked with 100 mg of liquid composition, the liquid composition remained absorbed in the absorbent without flowing out, during the test, a much greater amount of aerosol than in the existing heated cigarettes was observed, and a sufficient amount of aerosol derived from the liquid composition was observed, even compared to the existing hybrid types.

According to a preferred embodiment, the wrapping paper 61 forming the liquid cartridge 56 may come in the form of laminated paper made by attaching aluminum foil to paper, and is wrapped in a cylindrical shape so that the aluminum foil comes into contact with the absorbent 56a. Thus, the aluminum foil may eliminate or minimize the possibility that the liquid composition dampening the absorbent 56a may flow out through the side of the liquid cartridge 56. That is, as can be seen from the construction of the liquid cartridge shown in FIGS. 1 and 2, the absorbent 56a is wrapped in a separate piece of wrapping paper 61 before it is wrapped in the wrapping paper 60 used to form the smoking article. In this case, the wrapping paper 61 may come in the form of paper with aluminum foil attached to it, and it is desirable that the absorbent 56a be wrapped in a cylindrical shape so that the aluminum foil comes into contact with the absorbent 56a.

In some cases, the electrically heated smoking article may be manufactured in such a way that the liquid aerosol-forming substrate composition contains nicotine, and the tube and the filter are sequentially laminated on the liquid aerosol-forming substrate cartridge and wrapped in the wrapping paper. As shown in FIGS. 1 and 2, the electrically heated smoking article 50 according to the present invention may comprise the paper tube 54 for providing an aerosol passage, wherein PLA may be inserted into the tube to reduce the temperature of the aerosol to prevent the user from getting burned when inhaling the aerosol. The paper tube 54 also may be wrapped in a separate piece of wrapping paper (not shown). In this case, regular paper will suffice as the wrapping paper for the paper tube 54.

As shown in FIGS. 1 and 2, the filter 52 functioning as a mouthpiece allows aerosol to pass therethrough and blocks the inflow of liquid. As stated above, the liquid composition soaking through or dampening the absorbent 56a is kept within the liquid cartridge 56 in a normal and typical usage environment, but the liquid composition may partially flow out in an abnormal environment, such as when excessive external force is applied only to the liquid cartridge 56, in which case the filter serves to prevent the inflow of liquid (the paper tube may function similarly). The filter may be made of pulp in a cylindrical or tube shape. On the other hand, the filter may contain a flavoring component to increase the user’s satisfaction. Examples of the flavoring component may include licorice, sucrose, fructose syrup, isosweet, cocoa, lavender, cinnamon, cardamom, celery, cascarilla, fenugreek, cascarilla, sandalwood, bergamot, geranium, honey essence, rose oil, vanilla, lemon oil, orange oil, mint oil, caraway, cognac, jasmine, chamomile, menthol, ylang-ylang, salvia, spearmint, ginger, coriander, or coffee, etc.

Basically, the above-described liquid cartridge 56 may be made by employing the same process and equipment used to add a flavoring component to the filter 52. In this case, there will be no significant difficulties in achieving mass production and quality control since the existing process and equipment are used.

The electrically heated smoking article 50 is usually wrapped in wrapping paper 60 and 61 composed of multiple layers, such as first wrapping paper 61 wrapped around the liquid cartridge, second wrapping paper (not shown) wrapped around the liquid cartridge and the tube altogether, and third wrapping paper 60 wrapped around the whole parts of the electrically heated smoking article. In this manner, the electrically heated smoking article can be obtained through a number of stages of wrapping. In some cases, a process of forming the liquid cartridge can be carried out separately or through a continuous line.

Alternatively, in order to reduce the manufacturing time and cut down the manufacturing cost, packaging of different materials or different thicknesses may be added to the inside of the outermost wrapping paper wrapped around the whole parts of the electrically heated smoking article to wrap them altogether.

As shown in FIGS. 1 and 2, in the liquid cartridge 56 according to one embodiment of the present invention, the absorbent 56a with the liquid composition absorbed in it is wrapped in the wrapping paper 61 serving as a housing. In addition, the paper tube 54 and the filter 52 are stacked sequentially at the downstream end of the liquid cartridge 56. The filter and the paper tube are wrapped in the wrapping paper 60, together with the liquid cartridge.

The liquid composition in the liquid cartridge 56 remains absorbed in the absorbent in the liquid cartridge 56, without flowing out of the liquid cartridge, and is vaporized by heating to generate an aerosol.

Preferably, the wrapping paper 60 and 61 is made of a material that does not deform when heated to a high temperature or when in contact with liquid, or that does not generate harmful components. Alternatively, the wrapping paper may be made of a metal thin film or metal foil, or, as described above, may be made by adding a metal thin film or thin metal sheet to wrapping paper or by laminating them together. According to a preferred embodiment of the present invention, the wrapping paper 61 serving as a housing for the liquid cartridge 56 is composed of paper and aluminum foil laminated together, and the aluminum foil adjoins the absorbent 56a and therefore prevents the liquid composition absorbed in the absorbent from flowing out to the side of the liquid cartridge 56.

The filter 52 provided downstream of the liquid cartridge 56 may have a hollow portion for generating an airflow, but a filter with no hollow portion may also be used. The filter may be composed of one or more segments and may include at least one of a tube filter, a cooling structure and a recess filter, for example. The tube filter has an inner hollow portion. The tube filter and the recess filter may be made of cellulose acetate, and the tube functioning as the cooling structure may be made of pure polylactic acid (PLA) or a combination of polylactic acid and another degradable polymer.

More specifically, the filter 52 may be made of acetate, paper, PP, etc. and the wrapping paper wrapped around the filter may be classified as regular paper, porous paper, perforated paper, non-wrapped acetate (NWA), etc. In addition, the filter type may be classified as a mono filter composed of one segment or a composite (double, triple, etc.) filter composed of a number of segments. The filter may be made from acetate tow, plasticizer, activated charcoal, X-DNA, and wrapping paper. The acetate tow refers to an aggregate of continuous filaments of cellulose acetate, which plays a major role in determining draw resistance, which is the most important characteristic of the filter. The properties of the acetate tow are determined by denier.

The plasticizer makes cellulose acetate fibers soft and flexible to form bonds at the contact points between the fibers and make a fiber bundle more rigid. Triacetin is used as a plasticizer for cigarette filters.

The activated charcoal, which is one of the absorbents, contains carbon as the main constituent and can be classified by particle size and nature. Source materials used for the activated charcoal include plant materials, such as wood, sawdust, and fruit stones (coconut husk, bamboo, peach seeds, etc.).

X-DNA refers to functional particles that are extracted from sea algae and then condensed and processed. As compared with the activated charcoal mainly used for cigarette filters, X-DNA does not affect the taste of cigarettes and exhibits strong anticarcinogenic effects.

The wrapping paper serves to maintain the shape of a filter plug during the manufacture of the filter. The wrapping paper is required to satisfy physical properties, such as porosity, tensile strength, extension, thickness, glue adhesion, etc., in its manufacture.

For example, the liquid cartridge 56 may be 14.0 mm long, the filter 52 or the tube 54 may be 2.5 mm long, and the tobacco filler 58 containing shredded tobacco may be 9.0 mm long. Alternatively, for example, the filter may be 10 mm, the paper tube 54 may be 16 mm, the liquid cartridge 56 may be 10 mm, and the tobacco filler 58 may be 12 mm.

The relative lengths of the filter 52, paper tube 54 and liquid cartridge 56 may be associated with the temperature of an aerosol the user inhales that is generated from the electrically heated smoking article by means of an aerosol generating device 100 to be described later. The temperature of an aerosol generated from the liquid cartridge 56 can cause high-temperature aerosol to be cooled further as the paper tube 54 becomes longer. Thus, the temperature of aerosol generated from the liquid cartridge 56 may be taken into account, and the relative lengths thereof may vary with the amount of liquid composition dependent on the volume of the liquid cartridge 56 and the heating method used by the aerosol generating device to be described later. It would not be difficult for a person of ordinary skill in the art to satisfy the above conditions when making an electrically heated smoking article the same size as the electrically heated smoking articles currently on the market.

As described above, according to a preferred embodiment for manufacturing the liquid cartridge 56 shown in FIG. 3, an absorbent formed in a cylinder shape by the pipe structure 40 is passed through spray equipment or a liquid composition injection part such as a needle before it is inserted into the pipe structure 40, and enough of the liquid composition is sprayed or injected into the absorbent 56a, and the absorbent 56a becomes dampened or soaked with the liquid composition as it passes through the pipe structure 40. Afterwards, the absorbent with the liquid composition absorbed in it is wrapped in, for example, wrapping paper (or a laminate of paper and aluminum foil), and cut to a required length (for example, 140 mm, 100 mm, or 80 mm) to form an absorbent rod 57. As described later, the absorbent rod 57 may be cut up into a liquid cartridge 56 of a desired length (for example, 14 mm, 10 mm, or 8 mm), and then packed (wrapped) together with other segments (the tube, filter, and tobacco filler) of the electrically heated smoking article, thereby making an electrically heated smoking article 50 for generating an aerosol.

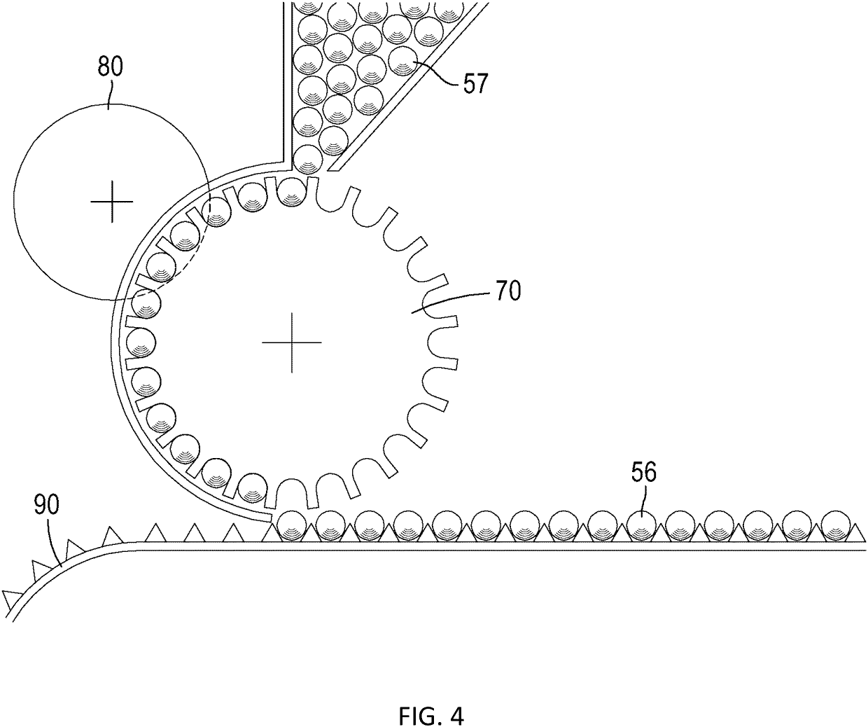

FIG. 4 is a view schematically illustrating a process of cutting the above-obtained absorbent rod 57 in order to manufacture a liquid cartridge 56 according to a preferred embodiment of the present invention. As described previously, the absorbent rod 57, which is 140 mm, 100 mm, or 80 mm long, for example, may be inserted into a groove in an index table 70 and moved to a conveyor belt 90 by the rotation of the index table. At this point, rotary blades 80 are placed on the moving path along the index table 70, and the absorbent rod 57 is cut into ten liquid cartridges 56 of a desired length, for example, 14 mm, 10 mm, or 80 mm by the rotary blades. Ten rotary blades 80 may be placed at equal intervals to cut a 140-mm absorbent rod 57 into ten 14-mm liquid cartridges 56, a 100-mm absorbent rod 57 into ten 10-mm liquid cartridges 56, or an 80-mm absorbent rod 57 into ten 8-mm liquid cartridges 56. As described previously, since the same process and equipment used to add flavoring components to the filter in the conventional manufacturing of cigarettes are employed, there will be no significant difficulties in achieving mass production and quality control.

According to a preferred embodiment of the present invention, the filter 52 functioning as a mouthpiece is located at the downstream end of the liquid cartridge 56. By packing these segments (filter, liquid cartridge, and tobacco filler) together, an electrically heated smoking article 50 for generating an aerosol can be made. As described previously, if necessary, the tube 54 which provides an aerosol passage and cools aerosols may be located between the filter 52 and the liquid cartridge 56. All of these segments — filter 52, tube 54, and liquid cartridge 56 —are arranged side by side and packed together, thereby obtaining an electrically heated smoking article 50 for generating an aerosol. In an actual manufacturing line, 10 or more sets of these segments are arranged and wrapped, and then cut into a number of electrically heated smoking articles.

In any case, the liquid composition in the liquid cartridge 56 remains absorbed in the absorbent 56a in the liquid cartridge, and does not flow out of the liquid cartridge 56. Since the liquid composition starts to generate an aerosol at about 120° C. or higher, any loss of the liquid composition during the manufacturing process can be prevented by performing process control at 100° C. or lower in the process of wrapping or making the liquid cartridge 56. In cases where a high temperature equal to or higher than a temperature where the liquid composition starts to vaporize is required during the manufacturing process, the liquid composition may be controlled in such a way that it is additionally absorbed by estimating the amount of liquid composition lost during the process and adding the estimated amount of loss to a required amount of liquid composition.

### Gel Aerosol-Forming Substrate Cartridge

The gel aerosol-forming substrate cartridge according to the present invention comprises: a gel aerosol-forming substrate containing glycerin and gelatin, which exists in gel form, semi-solid form, or solidified form (hereinafter, simply referred to as “gel form”) in a first temperature range including room temperature (for example, a temperature range below 50° C.), changes to a liquid form or a liquid in a second temperature range including 70° C. (for example, a temperature range of 50 to 100° C.), and is vaporized into an aerosol in a temperature range of 150 to 400° C.; a gel absorbent 56a that receives the gel aerosol-forming substrate; and wrapping paper 61 wrapped around the side of the gel absorbent 56a in a cylindrical shape measuring 7 to 20 mm long and 5 to 8 mm in diameter. The cylindrical shape measuring 7 to 20 mm long and 5 to 8 mm in diameter meets the standard for regular cigarettes or electrically heated smoking articles being currently used. When the gel aerosol-forming substrate cartridge 56 of the above standard is inserted into the electrically heated smoking article 50 and wrapped in a separate piece of wrapping paper 60, the user will see no difference with the regular cigarettes and electrically heated smoking articles.

Specifically, the gel aerosol-forming substrate is a mixture of glycerin and gelatin. For example, a mixture of glycerin and gelatin and/or water may be obtained by stirring glycerin PG (propylene glycol) or VG (vegetable glycerin) or a mixture of PG and VG for 30 minutes while applying heat, so as to lower the viscosity, adding 10 to 50 wt% gelatin and/or water as a gelling additive, and stirring it until the additive dissolves in the glycerin. The mixture is kept in gel form, semi-solid form, or solidified form in the first temperature range including room temperature (a temperature range below about 50° C.), changes to and exists in liquid form in the second temperature range including 70° C. (a temperature range of 50 to 100° C.) when heated, and generates an aerosol at about 150° C. or higher when further heated.

The above-described gel aerosol-forming substrate may additionally contain one or more among water, agar, a thickener, starch powder, celluloses, carboxymethyl ethers, natural food flavor, and fruit extract. Preferably, the content of glycerin in the gel aerosol-forming substrate is equal to or greater than 50 wt%. If water is contained, it can soften the gelatin and therefore reduce the time it takes to form a gel aerosol-forming substrate mixture. The mixture may additionally contain agar, which also becomes an advantage when forming the gel aerosol-forming substrate mixture. In addition, the gel aerosol-forming substrate mixture may contain, as additives, a thickener, starch powder, celluloses, and carboxymethyl ethers. The gel aerosol-forming substrate mixture may additionally contain natural food flavor or fruit extract. This allows for giving the user a variety of tastes through a generated aerosol. In any case, the content of glycerin in the gel aerosol-forming substrate mixture is preferably equal to or greater than 50 wt%, which minimizes the burnt taste of the generated aerosol. Moreover, the gel aerosol-forming substrate mixture may or may not contain nicotine.

Here, the gel aerosol-forming substrate contains a liquid composition made up of 80 to 100 wt% glycerin VG and 0 to 20 wt% glycerin PG, wherein 1 to 6 g of gelatin is contained in 100 ml of a mixture of 60 to 80% liquid composition and 20 to 40% water by volume, and flavorings are optionally added in an amount that is 10% or less of the total weight of the liquid composition. Preferably, the gel absorbent contains the liquid composition in an amount of 70 to 120 mg. This numerical range indicates the amount of liquid composition that provides an aerosol derived from the liquid composition as well when the user inhales an aerosol from the tobacco filler 58 of shredded tobacco in a single cigarette stick for the electrically heated smoking article. If the amount of liquid composition contained as the gel aerosol-forming substrate in the gel absorbent 56a is less than the above lower limit (70 mg), the amount of aerosol derived from the liquid composition when the user inhales an aerosol from the tobacco filler 58 of shredded tobacco in the electrically heated smoking article would be insufficient. Thus, the amount of liquid composition contained in the gel aerosol-forming substrate cartridge 56 should be equal to or greater than the above lower limit (70 mg). If the amount of liquid composition contained in the gel absorbent 56a exceeds the above upper limit (120 mg), the volume of the gel aerosol-forming substrate, i.e., mixture, may become too large, making it difficult for the gel absorbent in the gel aerosol-forming substrate cartridge 56 of the above standard to hold the liquid composition. Thus, the amount of liquid composition contained in the gel aerosol-forming substrate cartridge should be equal to or less than the above upper limit (120 mg). A desirable range is between 80 and 110 mg, and a more desirable range is between 90 and 105 mg.

Another characteristic of the present invention is that, as described later, the gel aerosol-forming substrate may exist in a liquid state in the manufacturing process, and, even in liquid form, the gel absorbent 56a in the gel aerosol-forming substrate cartridge of the above standard has a sufficient absorption rate to keep the liquid composition having the above composition range in the gel aerosol-forming substrate cartridge. That is, the liquid composition remains absorbed in the gel absorbent 56a in the gel aerosol-forming substrate cartridge, without flowing out of the gel aerosol-forming substrate cartridge. Here, the absorption means that the gel absorbent is soaked with the liquid composition which does not flow out. As described below, the filter 52, paper tube 54, gel aerosol-forming substrate cartridge 56, and tobacco filler 58 are wrapped in the wrapping paper 60 to form the electrically heated smoking article 50, wherein the gel aerosol-forming substrate cartridge 56 is brought into direct contact with the tobacco filler 58, paper tube 54, or filter 52 without a separate member upstream or downstream, and the liquid composition absorbed by the gel absorbent 56a in the gel aerosol-forming substrate cartridge 56 is stored in the gel absorbent 56a, but does not flow out toward the tobacco filler 58, paper tube 54, or filter 52. To this end, the amount of liquid composition absorbed by the gel absorbent 56a is preferably 0.13 to 0.32 mg/mm³ per unit volume of the gel absorbent 56a. This numerical limitation is set for a similar reason to why the numerical limitation is set on the amount of liquid composition absorbed by the gel absorbent 56a of the present invention. That is, if the amount of liquid composition absorbed by the gel absorbent 56a is not sufficient, i.e., less than the above lower limit (0.13 mg/mm³), the amount of aerosol derived from the liquid composition when the user inhales an aerosol from the shredded tobacco in the electrically heated smoking article 50 would be insufficient. Thus, the amount of liquid composition absorbed by the gel aerosol-forming substrate cartridge should be equal to or greater than the lower limit (0.13 mg/mm³). If the amount of liquid composition absorbed by the gel absorbent 56a exceeds the above upper limit (0.32 mg/mm³), it would be difficult to keep the liquid composition absorbed in the gel absorbent in the gel aerosol-forming substrate cartridge of the above standard, causing the liquid composition to flow out of the gel aerosol-forming substrate cartridge 56.

As used herein, the term “gel aerosol-forming substrate cartridge” refers to a cartridge 56 containing a gel aerosol-forming substrate that exists in gel form at room temperature, turns into liquid form in a temperature range including 70° C., e.g., from 50 to 100° C., and is vaporized into an aerosol in a temperature range, e.g., from 150 to 350° C. when heated further. For example, the gel aerosol-forming substrate is a gel mixture composed of a liquid composition, like glycerin VG (and optionally glycerin PG), gelatin, and water, that exists in gel form in a first temperature including room temperature and changes to liquid form in a second temperature range including 70° C. The gel aerosol-forming substrate changes to liquid form when heated by electrical induction or resistance heating by a separate aerosol generating device, and the liquid composition generates an aerosol when heated further. According to a preferred embodiment of the present invention, the liquid composition is 100 wt% glycerin VG, and, according to another preferred embodiment, the liquid composition is 80 wt% glycerin VG and 20 wt% glycerin PG.

According to another preferred embodiment, a gel mixture of glycerin and gelatin and/or water may be obtained by stirring the above liquid composition for 30 minutes while applying heat, so as to lower the viscosity, adding gelatin and/or water as a gelling additive, and stirring it until the additive dissolves in the glycerin. In this case, 1 to 6 g of gelatin is contained in 100 ml of a mixture of 60 to 80% liquid composition and 20 to 40% water by volume.

According to yet another preferred embodiment, 1 g, 1.5 g, and 2 g of gelatin were individually soaked and swelled in 10 ml of cold water, mixed with and dissolved in 50 ml of a liquid composition of 80 wt% glycerin VG and 20 wt% glycerin PG, and then left for 6 hours or longer at room temperature. The gelation went smoothly even at room temperature, and even more so with an increasing amount of gelatin. An increase in viscosity and a low level of gelation took place when the amount of gelatin was between 1 g to 1.5 g.

According to a further preferred embodiment, a gel aerosol-forming substrate was obtained by soaking and swelling 5 g of gelatin in 50 ml of cold water for 30 minutes, adding 100 ml of a liquid composition of 80 wt% glycerin VG and 20 wt% glycerin PG, and stirring and heating the mixture for 90 minutes at 75° C.

The gel aerosol-forming substrate is kept in gel form in the first temperature range (below about 50° C.) including room temperature, changes to and exists in liquid form in the second temperature range (from 50 to 100° C.) including 70° C. when heated, and generates an aerosol at about 120° C. or higher when heated further. As described later, the gel aerosol-forming substrate is liquefied by heating in the second temperature range during the manufacturing process, so as to be injected into the gel absorbent 56a, and the liquid is sprayed into the gel absorbent 56a or injected into it by a needle or the like so as to be absorbed into the gel absorbent 56a. Afterwards, the liquid is kept for 5 to 10 minutes at a low temperature, for example, about 4° C., or kept for 1 hour or longer at room temperature, whereby the liquid absorbed in the gel absorbent 56a turns into gel form and exists in the form of fine particles distributed over surfaces, pores, networks, etc. in the gel absorbent 56a.

Meanwhile, since the gel absorbent provides sufficient absorption of the liquid composition of the liquefied aerosol-forming substrate, the liquid composition does not flow out of the gel absorbent. Preferably, the gel aerosol-forming substrate additionally contains water, although it contains glycerin and gelatin as the main constituents, as described earlier. If water is contained, it can soften the gelatin and therefore reduce the time it takes to form a gel aerosol-forming substrate. The gel aerosol-forming substrate may additionally contain agar, which also becomes an advantage when forming a gel. In addition, the gel aerosol-forming substrate may contain, as additives, a thickener, starch powder, celluloses, and carboxymethyl ethers. The gel aerosol-forming substrate may additionally contain natural food flavor or fruit extract. This allows for giving the user a variety of tastes through a generated aerosol. In any case, the content of glycerin in the gel aerosol-forming substrate is preferably equal to or greater than 50 wt%, which minimizes the burnt taste of the generated aerosol.

As described previously, the liquid composition contains 80 to 100 wt% glycerin VG and 0 to 20 wt% glycerin PG and further contains flavorings added in an amount that is 10 % or less of the total weight of the resulting liquid composition. According to a preferred embodiment, the present invention uses a liquid composition made up of 100 wt% glycerin VG. According to another preferred embodiment, the present invention uses a liquid composition made up of 80 wt% glycerin VG and 20 wt% glycerin PG. According to yet another preferred embodiment, the present invention further contains flavorings added in an amount that is 10% or less of the total weight of the resulting liquid composition. For example, the flavorings may include licorice, sucrose, fructose syrup, isosweet, cocoa, lavender, cinnamon, cardamom, celery, cascarilla, fenugreek, cascarilla, sandalwood, bergamot, geranium, honey essence, rose oil, vanilla, lemon oil, orange oil, mint oil, caraway, cognac, jasmine, chamomile, menthol, ylang-ylang, salvia, spearmint, ginger, coriander, or coffee, etc. In addition, the liquid composition may or may not contain nicotine.

According to the present invention, the gel absorbent 56a may be made of various materials. Although FIGS. 1 and 2 illustrate that the gel absorbent 56a is formed in a rolled shape, this is only for convenience of description and the construction of the gel absorbent 56a is not limited thereto. Various types of gel absorbents 56a may be considered as stated below. Basically, a gel absorbent rod 57 may be obtained by crumpling or rolling the gel absorbent 56a, inserting it through one side of a pipe structure 40 shown in FIG. 3, pressing it into a shape with a narrower cross-section through the other side, and wrapping it in the wrapping paper 61. Before the gel absorbent 56a is inserted into the pipe structure 40, the liquefied gel aerosol-forming substrate is absorbed into the gel absorbent 56a through a liquid injection part such as a needle. As the gel absorbent 56a passes through the pipe structure 40, it becomes dampened or soaked with the liquefied gel aerosol-forming substrate, and is then wrapped in the wrapping paper 61 immediately on the other side of the pipe structure 40 and cut to an appropriate length, for example, 80 mm to 140 mm, thereby forming the gel absorbent rod 57. That is, the gel aerosol-forming substrate mixture is liquefied by heating in the second temperature range including 70° C., injected into the gel absorbent 56a through an injection part such as a needle, and absorbed into the gel absorbent 56a. The gel absorbent 56a may go through a proper cooling process before being cut to form the gel absorbent rod 57, or may be cut and then kept at room temperature for an appropriate amount of time, e.g., 1 hour, or at a low temperature, e.g., 4° C., for 5 to 10 minutes, since it provides sufficient absorption of the liquefied gel aerosol-forming substrate. In this manner, the gel aerosol-forming substrate in liquid form inserted into the gel absorbent 56a is turned into a gel, thereby preventing or minimizing the liquid composition from flowing out of the gel absorbent 56a during a subsequent operation (such as cutting to form cartridges or wrapping to form a smoking article). That is, the gel absorbent rod 57 may come in the form of the gel absorbent 56a dampened with the gel aerosol-forming substrate in liquid form and wrapped in the wrapping paper 61, or the gel absorbent rod 57 may be wrapped in the wrapping paper 61, with the gel aerosol-forming substrate existing in gel form in the gel absorbent 56a by means of a proper cooling structure provided in the pipe structure. Alternatively, as described earlier, the gel absorbent rod 57 may hold the mixture in gel form, which contains the aerosol-forming substrate inserted into the gel absorbent, as long as it is kept in the first temperature range including room temperature for a predetermined amount of time, and, as stated later, may be cut to a size that fits into an individual smoking article 50.

This construction is a generalized process in existing cigarette manufacturing lines, and has the advantage of using existing cigarette manufacturing processes and equipment. That is, the same process above applies to the conventional manufacturing of filters, paper tubes, and shredded tobacco, and the cartridge 56 can be produced using the equipment and processes currently used.

The gel aerosol-forming substrate may be easily absorbed into the gel absorbent to be described later, since it is inserted in liquid form into the gel absorbent in the second temperature range including 70° C., e.g., from 50 to 100° C., and may exist in gel form in spaces between surfaces, pores, and networks present in the gel absorbent, in the first temperature including room temperature, e.g., below 50° C. Thus, as long as the gel aerosol-forming substrate cartridge is kept in the first temperature range including room temperature, there is no or little possibility that the liquid composition contained in the gel aerosol-forming substrate might flow or leak out from the gel aerosol-forming substrate cartridge.

According to a preferred embodiment, the gel absorbent of the present invention is made by crumpling or rolling a strip made of a melamine-based foam resin with a thickness of 2 to 3 mm and inserting it into the above-mentioned pipe structure 40 to form a cylindrical shape. According to another preferred embodiment, the gel absorbent of the present invention is made by processing a melamine-based foam resin into a cylindrical shape and inserting and pressing it into the above-mentioned pipe structure 40, and more preferably, the gel absorbent made of the melamine-based foam resin has a weight of 0.01 to 0.013 mg/mm³ per unit volume. According to test results for the electrically heated smoking article including the gel aerosol-forming substrate cartridge corresponding to 100 mg of liquid composition, the liquid composition remained absorbed in the gel absorbent without flowing out, during the test, and a much greater amount of aerosol than in the existing heated cigarettes was observed, and a sufficient amount of aerosol derived from the liquid composition was observed, even compared to the existing hybrid types or the existing liquid compositions absorbed.

According to a further preferred embodiment, the gel absorbent of the present invention is made by crumpling, folding, or rolling pulp or a fabric containing pulp and inserting it into the above-mentioned pipe structure 40 to form a cylindrical shape or by processing it into a cylindrical shape and inserting and pressing it into the above-mentioned pipe structure 40, and more preferably, the gel absorbent made of pulp or a fabric containing pulp has a weight of 0.25 to 0.4 mg/mm³ per unit volume. According to test results for the electrically heated smoking article including the gel aerosol-forming substrate cartridge corresponding to 100 mg of liquid composition, the liquid composition remained absorbed in the gel absorbent without flowing out, during the test, and a much greater amount of aerosol than in the existing heated cigarettes was observed, and a sufficient amount of aerosol derived from the liquid composition was observed, even compared to the existing hybrid types or the existing liquid compositions absorbed.

According to a yet further preferred embodiment, the gel absorbent of the present invention is made by crumpling or rolling a cotton woven or non-woven fabric and inserting it into the above-mentioned pipe structure 40 to form a cylindrical shape or by processing it into a cylindrical shape and inserting and pressing it into the above-mentioned pipe structure 40, and more preferably, the gel absorbent made of a cotton woven or non-woven fabric has a weight of 0.2 to 0.35 mg/mm³ per unit volume. According to test results for the electrically heated smoking article including the gel aerosol-forming substrate cartridge corresponding to 100 mg of liquid composition, the liquid composition remained absorbed in the gel absorbent without flowing out, during the test, and a much greater amount of aerosol than in the existing heated cigarettes was observed, and a sufficient amount of aerosol derived from the liquid composition was observed, even compared to the existing hybrid types or the existing liquid compositions absorbed.

According to a yet further preferred embodiment, the gel absorbent of the present invention is made by crumpling or rolling a bamboo fiber woven or non-woven fabric and inserting it into the above-mentioned pipe structure 40 to form a cylindrical shape or by processing it into a cylindrical shape and inserting and pressing it into the above-mentioned pipe structure 40, and more preferably, the gel absorbent made of a bamboo fiber woven or non-woven fabric has a weight of 0.15 to 0.25 mg/mm³ per unit volume. According to test results for the electrically heated smoking article including the gel aerosol-forming substrate cartridge corresponding to 100 mg of liquid composition, the liquid composition remained absorbed in the gel absorbent without flowing out, during the test, and a much greater amount of aerosol than in the existing heated cigarettes was observed, and a sufficient amount of aerosol derived from the liquid composition was observed, even compared to the existing hybrid types or the existing liquid compositions absorbed.

According to a preferred embodiment, the wrapping paper 61 forming the gel aerosol-forming substrate cartridge 56 may come in the form of laminated paper made by attaching aluminum foil to paper, and is wrapped in a cylindrical shape so that the aluminum foil comes into contact with the gel absorbent 56a. Thus, the aluminum foil may eliminate or minimize the possibility that the gel aerosol-forming substrate in liquid form dampening the gel absorbent 56a may flow out through the side of the gel aerosol-forming substrate cartridge 56. That is, as can be seen from the construction of the gel aerosol-forming substrate cartridge shown in FIGS. 1 and 2, the gel absorbent 56a is wrapped in a separate piece of wrapping paper 61 before it is wrapped in the wrapping paper 60 used to form the smoking article. In this case, the wrapping paper 61 may come in the form of paper with aluminum foil attached to it, and it is desirable that the gel absorbent 56a be wrapped in a cylindrical shape so that the aluminum foil comes into contact with the gel absorbent 56a.

In some cases, the electrically heated smoking article may be manufactured in such a way that the gel aerosol-forming substrate composition contains nicotine, and the tube and the filter are sequentially laminated on the gel aerosol-forming substrate cartridge and wrapped in the wrapping paper.

As shown in FIGS. 1 and 2, the electrically heated smoking article 50 according to the present invention may comprise the paper tube 54 for providing an aerosol passage, wherein PLA may be inserted into the tube to reduce the temperature of the aerosol to prevent the user from getting burned when inhaling the aerosol. The paper tube 54 also may be wrapped in a separate piece of wrapping paper (not shown). In this case, regular paper will suffice as the wrapping paper for the paper tube 54.

As shown in FIGS. 1 and 2, the filter 52 functioning as a mouthpiece allows aerosol to pass therethrough and blocks the inflow of liquid. As stated above, the gel aerosol-forming substrate in the gel absorbent 56a is kept in gel form or the like within the gel absorbent 56a, in the first temperature range including room temperature, but the liquid composition may partially flow out in an abnormal environment, such as when the surroundings where the smoking article is stored reach the second temperature range or when excessive external force is applied only to the gel aerosol-forming substrate cartridge 56 in that circumstance, in which case the filter serves to prevent the inflow of liquid (the paper tube may function similarly). The filter may be made of pulp in a cylindrical or tube shape. On the other hand, the filter may contain a flavoring component to increase the user’s satisfaction. Examples of the flavoring component may include licorice, sucrose, fructose syrup, isosweet, cocoa, lavender, cinnamon, cardamom, celery, cascarilla, fenugreek, cascarilla, sandalwood, bergamot, geranium, honey essence, rose oil, vanilla, lemon oil, orange oil, mint oil, caraway, cognac, jasmine, chamomile, menthol, ylang-ylang, salvia, spearmint, ginger, coriander, or coffee, etc.

Basically, the above-described gel aerosol-forming substrate cartridge 56 may be made by employing the same process and equipment used to add a flavoring component to the filter 52. In this case, there will be no significant difficulties in achieving mass production and quality control since the existing process and equipment are used.

The electrically heated smoking article 50 is usually wrapped in wrapping paper 60 and 61 composed of multiple layers, such as first wrapping paper 61 wrapped around the gel aerosol-forming substrate cartridge, second wrapping paper (not shown) wrapped around the gel aerosol-forming substrate cartridge and the tube altogether, and third wrapping paper 60 wrapped around the whole parts of the electrically heated smoking article. In this manner, the electrically heated smoking article can be obtained through a number of stages of wrapping. In some cases, a process of forming the gel aerosol-forming substrate cartridge can be carried out separately or through a continuous line.

Alternatively, in order to reduce the manufacturing time and cut down the manufacturing cost, packaging of different materials or different thicknesses may be added to the inside of the outermost wrapping paper wrapped around the whole parts of the electrically heated smoking article to wrap them altogether.

As shown in FIGS. 1 and 2, in the gel aerosol-forming substrate cartridge 56 according to one embodiment of the present invention, the gel absorbent 56a, with the gel aerosol-forming substrate containing the liquid composition received in it, is wrapped in the wrapping paper 61 serving as a housing. In addition, the paper tube 54 and the filter 52 are stacked sequentially at the downstream end of the gel aerosol-forming substrate cartridge 56. The filter and the tube are wrapped in the wrapping paper 60, together with the gel aerosol-forming substrate cartridge.

The gel aerosol-forming substrate in the gel aerosol-forming substrate cartridge 56 is kept in gel form or the like in the gel absorbent in the gel aerosol-forming substrate cartridge 56, in the first temperature range, and the liquid composition contained in the gel aerosol-forming substrate does not flow out of the gel aerosol-forming substrate cartridge 56, and is vaporized by heating to generate an aerosol.

Preferably, the wrapping paper 60 and 61 is made of a material that does not deform when heated to a high temperature or when in contact with liquid, or that does not generate harmful components. Alternatively, the wrapping paper may be made of a metal thin film or metal foil, or, as described above, may be made by adding a metal thin film or thin metal sheet to wrapping paper or by laminating them together. According to a preferred embodiment of the present invention, the wrapping paper 61 serving as a housing for the gel aerosol-forming substrate cartridge 56 is composed of paper and aluminum foil laminated together, and the gel absorbent 56a is placed on the aluminum foil adjoining it, in the second temperature range during manufacture or storage, thereby preventing the gel aerosol-forming substrate from turning into a liquid state and flowing out of the side of the gel aerosol-forming substrate cartridge 56.

The filter 52 provided downstream of the gel aerosol-forming substrate cartridge 56 may have a hollow portion for generating an airflow, but a filter with no hollow portion may also be used. The filter may be composed of one or more segments and may include at least one of a tube filter, a cooling structure and a recess filter, for example. The tube filter has an inner hollow portion. The tube filter and the recess filter may be made of cellulose acetate, and the tube functioning as the cooling structure may be made of pure polylactic acid (PLA) or a combination of polylactic acid and another degradable polymer.

More specifically, the filter 52 may be made of acetate, paper, PP, etc. and the wrapping paper wrapped around the filter may be classified as regular paper, porous paper, perforated paper, non-wrapped acetate (NWA), etc. In addition, the filter type may be classified as a mono filter composed of one segment or a composite (double, triple, etc.) filter composed of a number of segments. The filter may be made from acetate tow, plasticizer, activated charcoal, X-DNA, and wrapping paper. The acetate tow refers to an aggregate of continuous filaments of cellulose acetate, which plays a major role in determining draw resistance, which is the most important characteristic of the filter. The properties of the acetate tow are determined by denier.

The plasticizer makes cellulose acetate fibers soft and flexible to form bonds at the contact points between the fibers and make a fiber bundle more rigid. Triacetin is used as a plasticizer for cigarette filters.

The activated charcoal, which is one of the absorbents, contains carbon as the main constituent and can be classified by particle size and nature. Source materials used for the activated charcoal include plant materials, such as wood, sawdust, and fruit stones (coconut husk, bamboo, peach seeds, etc.).

X-DNA refers to functional particles that are extracted from sea algae and then condensed and processed. As compared with the activated charcoal mainly used for cigarette filters, X-DNA does not affect the taste of cigarettes and exhibits strong anticarcinogenic effects.

The wrapping paper serves to maintain the shape of a filter plug during the manufacture of the filter. The wrapping paper is required to satisfy physical properties, such as porosity, tensile strength, extension, thickness, glue adhesion, etc., in its manufacture.

For example, the gel aerosol-forming substrate cartridge 56 may be 14.0 mm long, the filter 52 or the tube 54 may be 2.5 mm long, and the tobacco filler 58 containing shredded tobacco may be 9.0 mm long. Alternatively, for example, the filter 52 may be 10 mm, the paper tube 54 may be 16 mm, the gel aerosol-forming substrate cartridge 56 may be 10 mm, and the tobacco filler 58 may be 12 mm.

The relative lengths of the filter 52, paper tube 54, and gel aerosol-forming substrate cartridge 56 may be associated with the temperature of an aerosol the user inhales that is generated from the electrically heated smoking article by means of an aerosol generating device 100 to be described later. The temperature of an aerosol generated from the gel aerosol-forming substrate cartridge 56 can cause high-temperature aerosol to be cooled further as the paper tube 54 becomes longer. Thus, the temperature of aerosol generated from the gel aerosol-forming substrate cartridge 56 may be taken into account, and the relative lengths and positioning thereof may vary with the amount of liquid composition dependent on the volume of the gel aerosol-forming substrate cartridge 56 and the heating method used by the aerosol generating device to be described later. It would not be difficult for a person of ordinary skill in the art to satisfy the above conditions when making an electrically heated smoking article the same size as the electrically heated smoking articles currently on the market.

As described above, according to a preferred embodiment for manufacturing the gel aerosol-forming substrate cartridge 56 shown in FIG. 3, a gel aerosol-forming substrate is first made into a liquid by heating in the second temperature range, and then a gel absorbent 56a formed in a cylinder shape by the pipe structure 40 is passed through spray equipment or a liquid injection part such as a needle before it is inserted into the pipe structure 40, and enough of the liquid is sprayed or injected into the gel absorbent 56a, and the gel absorbent 56a becomes dampened or soaked with the liquid as it passes through the pipe structure 40. Afterwards, the gel absorbent with the liquid absorbed in it is wrapped in, for example, wrapping paper (or a laminate of paper and aluminum foil), and cut to a required length (for example, 140 mm, 100 mm, or 80 mm) to form a gel absorbent rod 57. As described later, the gel absorbent rod 57 may be cut up into a gel aerosol-forming substrate cartridge 56 of a desired length (for example, 14 mm, 10 mm, or 8 mm), and then packed (wrapped) together with other segments (the tube, filter, and tobacco filler) of the electrically heated smoking article, thereby making an electrically heated smoking article 50 for generating an aerosol. As described previously, the liquid inserted into the gel absorbent 56a turns into a gel while maintaining the first temperature range, once the gel absorbent 56a passes through the pipe structure 40 or goes into storage after being cut to form the gel absorbent rod 57 or the gel aerosol-forming substrate cartridge 56. In turn, the gel exists in the form of fine particles distributed over surfaces, pores, networks, etc. in the gel absorbent 56a.

FIG. 4 is a view schematically illustrating a process of cutting the gel absorbent rod 57 in order to manufacture a gel aerosol-forming substrate cartridge 56 according to another preferred embodiment of the present invention. As described previously, the gel absorbent rod 57, which is 140 mm, 100 mm, or 80 mm long, for example, may be inserted into a groove in an index table 70 and moved to a conveyor belt 90 by the rotation of the index table. At this point, rotary blades 80 are placed on the moving path along the index table 70, and the gel absorbent rod 57 is cut into ten gel aerosol-forming substrate cartridges 56 of a desired length, for example, 14 mm, 10 mm, or 80 mm by the rotary blades. Ten rotary blades 80 may be placed at equal intervals to cut a 140-mm gel absorbent rod 57 into ten 14-mm gel aerosol-forming substrate cartridges 56, a 100-mm gel absorbent rod 57 into ten 10-mm gel aerosol-forming substrate cartridges 56, or an 80-mm gel absorbent rod 57 into ten 8-mm gel aerosol-forming substrate cartridges 56. As described previously, since the same process and equipment used to add flavoring components to the filter in the conventional manufacturing of cigarettes are employed, there will be no significant difficulties in achieving mass production and quality control.

According to a preferred embodiment of the present invention, the filter 52 functioning as a mouthpiece is located at the downstream end of the gel aerosol-forming substrate cartridge 56, and the tobacco filler 58 containing shredded tobacco is located at the upstream end of the gel aerosol-forming substrate cartridge 56. By packing these segments (filter, gel aerosol-forming substrate cartridge, and tobacco filler) together, an electrically heated smoking article for generating an aerosol can be made. As described previously, if necessary, the tube 54 which provides an aerosol passage may be located between the filter 52 and the gel aerosol-forming substrate cartridge 56. All of these segments — filter, tube, gel aerosol-forming substrate cartridge, and tobacco filler — are arranged side by side and packed together, thereby obtaining an electrically heated smoking article 50 for generating an aerosol. In an actual manufacturing line, 10 or more sets of these segments are arranged and wrapped, and then cut into a number of electrically heated smoking articles.

In any case, the liquid composition, which is the aerosol-forming substrate contained in the gel aerosol-forming substrate cartridge 56, turns into a gel, and the gel exists in the form of fine particles distributed over surfaces, pores, networks, etc. in the gel absorbent within the gel aerosol-forming substrate cartridge. The liquid composition, even in liquid form, is absorbed by the gel absorbent 56a and therefore does not flow out of the gel aerosol-forming substrate cartridge. Nevertheless, in the process of manufacturing an electrically heated smoking article or after completing the electrically heated smoking article, the liquid composition may flow out due to high-temperature heat or physical pressure applied to the gel aerosol-forming substrate cartridge, or may be vaporized into an aerosol and exit to the outside. First of all, according to a preferred embodiment of the present invention, the filter is located downstream of the gel aerosol-forming substrate cartridge, and therefore it is unlikely that the liquid composition may flow out through the filter even if high-temperature heat or external physical force is applied to the gel aerosol-forming substrate cartridge. Since the gel aerosol-forming substrate turns into a liquid in the second temperature range including 70° C. and the liquid composition starts to generate an aerosol at about 120° C. or higher, any loss of the liquid composition during the manufacturing process can be prevented by performing process control at 100° C. or lower, preferably, in the first temperature range below 50° C., in the process of wrapping or making the gel aerosol-forming substrate cartridge. In cases where a high temperature equal to or higher than a temperature where the liquid composition starts to vaporize is required during the manufacturing process, the liquid composition may be controlled in such a way that it is additionally absorbed by estimating the amount of liquid composition lost during the process and adding the estimated amount of loss to a required amount of liquid composition.

### Aerosol Generating Device

Embodiments of an aerosol generating device 100 that can generate an aerosol by heating the electrically heated smoking article 50 according to the present invention will now be described. The aerosol generating device 100 to be described below is a grippable and portable-sized aerosol generating device that comprises an aerosol-forming substrate such as a liquid composition within the electrically heated smoking article 50 described herein, has a cavity into which the electrically heated smoking article 50 wrapped in wrapping paper in the shape of a traditional cigarette is inserted, and forms an aerosol by heating the aerosol-forming substrate of the smoking article inserted into the cavity by a heater provided in the aerosol generating device. As stated below, the heater may be a resistance heater or induction heater, which may be heated up to 100 to 400° C. to heat the aerosol-forming substrate within the electrically heated smoking article 50 inserted into the cavity of the aerosol generating device, thereby generating an aerosol. According to a preferred embodiment, the target temperature may range between 200 and 350° C., and more preferably, between 250 and 320° C. (for example, the target temperature may be set to 280° C.). In some cases, the target temperature may range between 150 and 250° C. (for example, the target temperature may be set to 180° C.), and may vary depending on the composition and additives of the liquid composition (glycerin, etc.) from which an aerosol is generated. In any of these cases, an aerosol generated in the electrically heated smoking article 50 is inhaled into the mouth of the user through the tube 54 and the filter 52. Thus, if the temperature of the generated aerosol is too high, even if the aerosol is cooled through the inhalation, the user may feel discomfort or get burned. Moreover, too much aerosol may be generated, making it difficult to take multiple puffs. With this taken into consideration, the target temperature of a heating element should be preset. For these reasons, the above upper limit is set on the target temperature of the heating element.

According to a preferred embodiment, the temperature of a generated aerosol measured after it passes through the tube 54 and the filter 52 may be a mouth end temperature. The temperature of the aerosol should be lower than 50° C., preferably, 45° C. or lower. A desirable temperature range for the aerosol at the mouth end is 25 to 45° C., and a more desirable temperature range for the aerosol at the mouth end is 30 to 40° C.

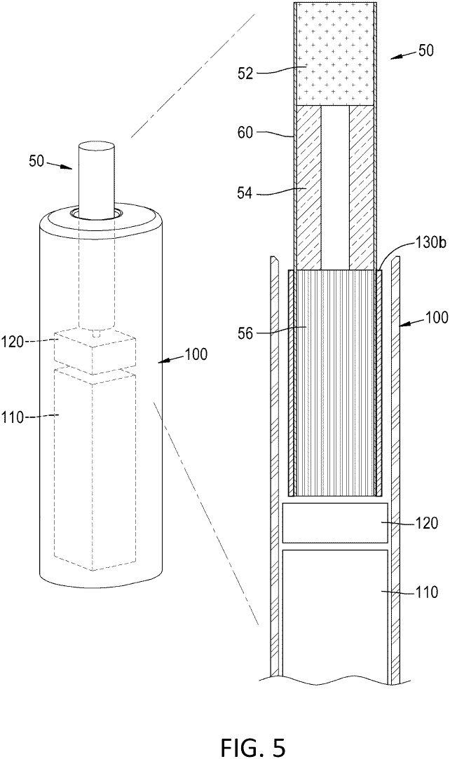

The aerosol generating device 100 commonly comprises a rechargeable battery 110 that is provided into the device and functions as a DC power source and a control unit 120 that controls the output from the battery 110. FIG. 5 depicts a conceptual diagram of the aerosol generating device 100, together with the electrically heated smoking article 50, and schematically shows a cross-section of the aerosol generating device 100 to explain the heating method for each embodiment. For convenience of explanation, the electrically heated smoking article 50 will be described basically with respect to a construction in which the filter 52, the tube 54, and the aerosol-forming substrate cartridge 56 are arranged in the order named and wrapped in the wrapping paper 60.

The following descriptions are provided only for illustrative purposes, and the scope of the present invention is not limited thereto. Those skilled in the art to which the present invention pertains will easily understand that an aerosol generating system within the scope of the present invention can be constructed by deleting or adding some of the components of the aerosol generating device exemplified below or combining it with another device.

FIG. 5 is a view schematically illustrating a cross-section of an aerosol generating device 100 according to a first embodiment of the present invention, along with a conceptual diagram of an exemplary aerosol generating system to which the present invention may apply, as stated above.

An aerosol generating system comprise an aerosol generating device 100 and an electrically heated smoking article 50. Here, the electrically heated smoking article 50 is constructed by wrapping the filter 52, paper tube 54, and aerosol-forming substrate cartridge 56 in the wrapping paper 60, as described above, and is inserted into a cavity formed in the aerosol generating device 100.

The aerosol generating device 100 comprises a resistance pipe heater 130b that corresponds to the aerosol-forming substrate cartridge 56. The pipe heater 130b is a pipe with a heater line or planar heating element pattern printed or provided on the outside, and the pipe heater 130b has a temperature sensor pattern so as to sense the temperature and control the power supply to the pipe heater 130b according to the sensed value. The pipe heater 130b heats the aerosol-forming substrate cartridge 56 of the electrically heated smoking article 50 from the side of the aerosol-forming substrate cartridge 56 so that an aerosol is generated as the aerosol-forming substrate existing in gel form or liquid form in the aerosol-forming substrate cartridge 56 is heated. The pipe heater 130b heats the aerosol-forming substrate cartridge 56 to basically the same temperature. The target temperature may be within a temperature range of 150 to 350° C., and may be adjusted according to the sensed temperature. Within the above temperature range, the wrapping paper is not combusted but may be partially scorched.

Needless to say, the heater pattern of the pipe heater 130b, the sensing unit, and the control unit 120 are electrically connected, and the battery 110 and the control unit 120 are also electrically connected. It is desirable that the pipe heater 130b only covers the aerosol-forming substrate cartridge 56 but not the paper tube 54 or the filter 52.

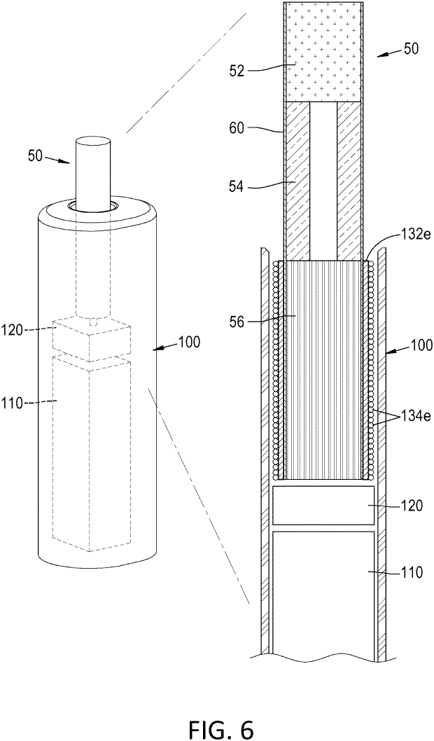

FIG. 6 illustrates an aerosol generating system to which an induction heater is applied, according to a second embodiment of the present invention. The electrical components used for induction heating are parts for induction heating, which include an excitation coil 134e wound multiple times in a cylindrical shape, and a susceptor (magnetic heating element) which reacts with the excitation coil 134e so that induction heating occurs due to eddy current losses. Here, the susceptor is a metal heat pipe 132e which is provided inside the excitation coil 134e to be surrounded by the excitation coil 134e in the device, which is made of a hollow cylindrical thin plate defining a cavity into which the electrically heated smoking article 50 can be inserted, and which is heated to a temperature of 400° C. or lower by induction heating due to eddy current losses, by reaction with the excitation coil 134e. The susceptor may be heated to a temperature of 1,000° C. or higher depending on the magnitude of the alternating current applied to the excitation coil 134e, whereas, in the present invention, the susceptor functioning as a heating element is heated to a temperature of 400° C. or lower, as stated above. The temperature of the heat pipe 132e may be sensed by a temperature sensor that makes physical contact with the surface of the heat pipe 132e, or the temperature of the susceptor may be calculated based on current and voltage changes detected by a current sensor and voltage sensor which measure changes in the current and voltage for heating the susceptor depending on the inductance or reactance varying with changes in the temperature of the susceptor functioning as the heat pipe 132e.

In order for induction heating to occur, the control unit receives direct current power from the battery 110 and supplies an alternating current having a resonance frequency or an alternating current having a frequency different from the resonance frequency to the excitation coil. By controlling the alternating current applied to the excitation coil based on changes in the temperature of the susceptor, the susceptor may be heated to a desired temperature, be maintained at that temperature, or have temperature changes.

The electrically heated smoking article 50 is constructed in the same manner as in the foregoing embodiment.

The aerosol generating device 100 according to the second embodiment works by heating the aerosol-forming substrate cartridge 56 by the induction heat pipe 132e. As the heat pipe 132e is heated, an aerosol is generated from the aerosol-forming substrate existing in gel form or liquid form in the absorbent of the aerosol-forming substrate cartridge 56. The heat pipe 132e of the second embodiment heats the gel aerosol-forming substrate cartridge 56 to basically the same temperature. The target temperature may be within a temperature range of 150 to 350° C., and may be adjusted according to the sensed temperature. Within the above temperature range, the wrapping paper is not combusted but may be partially scorched.

Needless to say, the excitation coil 134e, the sensing unit, and the control unit 120 are electrically connected, and the battery 110 and the control unit 120 are also electrically connected. It is desirable that the heat pipe 132e only covers the gel aerosol-forming substrate cartridge 56 but not the paper tube 54 or the filter 52.

As described above, a resistance pipe heater or an induction heat pipe that can heat the exterior of the aerosol-forming substrate cartridge is preferably used as the heater for the aerosol generating device. A resistance invasive heater or an induction heat blade that is inserted into the aerosol-forming substrate cartridge may be taken into account. However, as described above, the aerosol-forming substrate cartridge 56 is formed by crumpling or rolling physically connected materials; therefore, there is a possibility that this type of heater or heating element may not be properly inserted and, even if so, the absorbent may not be properly separated when the heater or heating element is removed. If the material of the absorbent is the same as that of shredded tobacco, the resistance invasive heater or the induction heat blade may be used alone or in combination with the pipe heater or heat pipe discussed earlier.

A person with ordinary skill in the art to which the present invention pertains will understand that the present invention may be implemented in a modified form within the scope which does not deviate from the essential characteristics of the present invention. Therefore, the methods disclosed in the above should be considered from an explanatory point of view, not a limited point of view. The scope of the present invention is defined by the claims, not the foregoing description, and all of the differences within the scope equivalent thereto should be interpreted to be included in the scope of the present invention.

According to the present invention, it is possible for the user to inhale an aerosol derived from a liquid and an aerosol derived from a tobacco substrate together, by providing a liquid aerosol-forming substrate cartridge that can be inserted into an electrically heated smoking article and an electrically heated smoking article including the same.

What is claimed is:

1-19. (canceled)

20. An aerosol generating system, comprising:
an electrically heated smoking article including a filter, a cartridge comprising an absorbent receiving a liquid and/or gel aerosol-forming substrate, and wrapping paper wrapped around the filter and cartridge; and
an aerosol generating device configured to heat the electrically heated smoking article.

21. The aerosol generating system of claim 20, wherein the absorbent has an absorption rate to absorb 70 to 120 mg of the liquid aerosol-forming substrate and keep the same in the cartridge.

22. The aerosol generating system of claim 20, wherein the liquid aerosol-forming substrate comprises 70 to 100 wt% glycerin VG.

23. The aerosol generating system of claim 20, wherein the liquid aerosol-forming substrate comprises at least 70 wt% glycerin VG, 20 wt% or less glycerin PG, 10 wt% or less water, and flavorings added in an amount that is 10% or less of the total weight of the resulting liquid composition.

24. The aerosol generating system of claim 20, wherein the gel aerosol-forming substrate comprises glycerin and gelatin which exists in gel form, semi-solid form, or solidified form in a first temperature range including room temperature, changes to a liquid form in a second temperature range including 70° C., and is vaporized into an aerosol in a temperature range of 150 to 400° C.

25. The aerosol generating system of claim 24, wherein the gel aerosol-forming substrate further comprises one or more of water, agar, a thickener, starch powder, celluloses, carboxymethyl ethers, natural food flavor, or fruit extract.

26. The aerosol generating system of claim 24, wherein the content of glycerin in the gel aerosol-forming substrate is equal to or greater than 50 wt%.

27. The aerosol generating system of claim 24, wherein the gel aerosol-forming substrate comprises a liquid composition made up of 80 to 100 wt% glycerin VG and 0 to 20 wt% glycerin PG, wherein 1 to 6 g of gelatin is contained in 100 ml of a mixture of 60 to 80% liquid composition and 20 to 40% water by volume.

28. The aerosol generating system of claim 27, wherein the gel absorbent comprises the liquid composition in an amount of 70 to 120 mg.

29. The aerosol generating system of claim 24, wherein the gel aerosol-forming substrate is inserted in liquid form into the gel absorbent in the second temperature range, and exists in gel form, semi-solid form, or solidified form in the first temperature range.

30. The aerosol generating system of claim 20, wherein the absorbent comprises a melamine-based foam resin having a thickness of 2 to 3 mm and a cylindrical shape.

31. The aerosol generating system of claim 30, wherein the melamine-based foam resin has a weight of 0.01 to 0.013 mg/mm³ per unit volume.

32. The aerosol generating system of claim 20, wherein the absorbent comprises pulp or a fabric containing pulp and has a cylindrical shape.

33. The aerosol generating system of claim 32, wherein the pulp or fabric containing pulp has a weight of 0.25 to 0.4 mg/mm³ per unit volume.

34. The aerosol generating system of claim 20, wherein the absorbent comprises a cotton fabric having a cylindrical shape.

35. The aerosol generating system of claim 34, wherein the cotton fabric has a weight of 0.2 to 0.35 mg/mm³ per unit volume.

36. The aerosol generating system of claim 20, wherein the absorbent comprises a bamboo fiber fabric having a cylindrical shape.

37. The aerosol generating system of claim 36, wherein the bamboo fiber fabric has a weight of 0.15 to 0.25 mg/mm³ per unit volume.

38. The aerosol generating system of claim 36, wherein the aerosol-forming substrate is absorbed in the liquid absorbent, in an amount of 0.13 to 0.32 mg/mm³ per unit volume of the absorbent.

39. The aerosol generating system of claim 20, wherein the wrapping paper comprises aluminum foil attached to paper and has a cylindrical shape so that the aluminum foil comes into contact with the absorbent.

40. The aerosol generating system of claim 20, further comprising a tubular body directly upstream of the filter.

41. The aerosol generating system of claim 20, further comprising:
a cavity into which the smoking article is configured to be inserted;
at least one of a resistance heater or an induction heater configured to heat an interior or exterior of a liquid cartridge and tobacco filler of the smoking article;
a rechargeable battery configured to function as a direct current power source; and
a control unit configured to control the at least one of the resistance heater or the induction heater by receiving direct current power from the battery.

42. The aerosol generating system of claim 41, wherein the resistance heater is a pipe heater configured to heat the exterior of the smoking article, wherein the pipe heater is configured to heat the aerosol-forming substrate cartridge and further comprises a temperature sensor provided in the aerosol generating device and configured to sense the temperatures of the at least one of the resistance heater or the induction heater, and wherein the control unit is configured to control the resistance heater according to a sensed value from the temperature sensor.

43. The aerosol generating system of claim 41, wherein the induction heater is a heat pipe made of a susceptor material that is configured to heat the exterior of the smoking article, heated by an excitation coil provided separately in the aerosol generating device, wherein the heat pipe is configured to heat the aerosol-forming substrate cartridge and further comprises a temperature obtaining unit provided in the aerosol generating device and configured to obtain the temperature of the induction heater, and wherein the control unit is configured to control the electrical current applied to the excitation coil based on an input from the temperature obtaining unit.
